(19) United States
(12) Patent Application Publication
(10) Pub. No.: US 2005/0098708 A1
(43) Pub. Date: May 12, 2005

(54) Optical sampling measurement apparatus and optical sampling measurement method

(76) Inventors: Yoshiki Yanagisawa, Yokohama-shi (JP); Yoshikazu Kawaguchi, Yokohama-shi (JP); Hiromi Yoshida, Tokyo (JP)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/983,432

(22) Filed: Nov. 8, 2004

(30) Foreign Application Priority Data
Nov. 10, 2003 (JP) P.2003-379271

(51) Int. Cl. G01J 1/32

(52) U.S. Cl. 250/205

(57) ABSTRACT

The optical sampling measurement introduces an object light ejected from a light source and a sampling pulse light ejected from an active mode-locked fiber laser into a non-linear optical device, thereby to perform an equivalent time sampling of the object light. A signal, which is obtained by receiving a summed frequency light ejected from the non-linear optical device, at a photoreceiver, is fed back so that the repetition frequency of the active mode-locked fiber laser is controlled by a controller.

### BACKGROUND OF THE INVENTION

1. Field of the Invention

The present invention relates to an optical sampling measurement apparatus for measuring the waveform or the like of that object light in an ultra short time zone, which cannot be observed with the method using a photoelectric conversion element, by sampling the object light using the non-linear optical effect, and further to an optical sampling measurement method.

2. Description of the Related Art

In recent years, the optical communication technology has drastically progressed to vigorously develop the optical sampling measurement apparatus for measuring the waveforms or the like of optical pulses propagating in optical fibers acting as optical transmission paths. As one kind of this optical sampling measurement apparatus, there has been devised an optical sampling measurement apparatus for measuring the waveform or the like of an object light, by introducing the object light and a sampling pulse light having a timely narrow pulse shape into a non-linear optical device so that their summed frequency light may be generated in the non-linear optical device to sample the object light, and by receiving the summed frequency light generated with a light receiving element such as an avalanche photodiode.

The sampling method is divided into a real time sampling method and an equivalent time sampling method. The real time sampling method is required to use a sampling pulse light having a frequency twice or more larger than the maximum of the object light so that the method finds it difficult to measure the object light in the ultra short zone. Therefore, the optical sampling measurement apparatus employs the equivalent time sampling method for sampling the object light by shifting it many times.

For the measurement of the object light using the equivalent time sampling method, the object light and the sampling pulse light have to be synchronized with each other. Therefore, the optical sampling measurement apparatus of the related art feeds an electric signal having a predetermined repetition frequency, to a mode-locked fiber ring laser (as will be called the “MLFRL”) for ejecting the object light and a sampling pulse light source for ejecting the sampling pulse light. For example, the MLFRL for ejecting the object light is fed with an electric signal having a frequency fsig, and the sampling pulse light source for ejecting the sampling pulse light is fed with an electric signal which is synchronized with the electric signal fed to the MLFRL and which has a frequency of {(fsig/n)−Δf}. Here, letter n designates an integer, and letters Δf designate a minute frequency.

The electric signal having the frequency fsig is fed to the MLFRL, but the electric signal having the divided frequency of {(fsig/n)−Δf} is fed to the sampling pulse light source. Moreover, these signals are synchronized with each other so that the waveform of the repetition frequency “fsig” can be enlarged into the waveform having the repetition frequency of “(fsig/(n·Δf)”. This method measures the waveform of the object light in the ultra short time zone, which cannot be observed by the method using the photoelectric conversion element. Here, the optical sampling measurement apparatus of the related art should be referred to JP-A-8-29814 and JP-A-2003-35602, for example.

Here, the optical sampling measurement apparatus has to feed the synchronized electric signals to both the MLFRL for ejecting the object light and the sampling pulse light source for ejecting the sampling pulse. Therefore, the optical sampling measurement apparatus of the related art has to be separately prepared with a signal generating device for generating the electric signal to be fed to the MLFRL. The electric signal to be fed from the signal generating device has to be fed to the MLFRL, and the electric signal to be fed to the sampling pulse light source has to be generated from the electric signal fed to the signal generating device and has to be fed to the sampling pulse light source. Thus, the optical sampling measurement apparatus of the related art has a problem to have a complicated configuration.

Moreover, the optical sampling measurement apparatus of the related art has to feed the electric signal from the signal generating device to both the MLFRL and the sampling pulse light source. This causes a problem that the measurement conditions are restricted. In case a laid long-distance optical fiber is to be tested, for example, the distance is long between the incidence position of the object light on the optical fiber and the ejection position (i.e., the position to receive the object light) of the object light through the optical fiber. In this case, the MLFRL for ejecting the object light to be introduced into the optical fiber and the sampling pulse light source for ejecting the sampling pulse for sampling the object light through the optical fiber are arranged remotely of each other. Thus, the feed of the synchronized electric signals to both of them is extremely difficult and may be actually impossible depending on the distance of the long-distance optical fiber.

### SUMMARY OF THE INVENTION

The object of the invention is to provide an optical sampling measurement apparatus and an optical sampling measurement method which are capable of measuring an object light with a sampling pulse light synchronized with the object light but without an electric signal fed from the outside.

The invention provides an optical sampling measurement apparatus having: a light source (21) for ejecting a sampling pulse light (P5, P6) whose repetition frequency is controllable; and a non-linear optical device (24) for receiving an object light (P4) to be measured and the sampling pulse light incident from the light source, wherein the measurement of the object light is performed by measuring a light (P8) ejected from the non-linear optical device, further having a feedback control section (25, 28, 29) that controls the repetition frequency of the sampling pulse light ejected from the light source in accordance with a repetition frequency of the light ejected from the non-linear optical device.

According to the apparatus, the repetition frequency of the light source for ejecting the sampling pulse light is controlled according to the repetition frequency of the light ejected from the non-linear optical device, so that the sampling pulse light ejected from the light source is synchronized with the object light.

In the optical sampling measurement apparatus, the feedback control section controls the repetition frequency of the light source so that a difference between a frequency of one n-th (“n” is a quotient obtained by dividing a repetition frequency of the object light by a repetition frequency of the sampling pulse light) of a frequency of the object light and the repetition frequency of the sampling pulse light is always a predetermined value.

In the optical sampling measurement apparatus, the feedback control section includes: a photoreceiver (25) for receiving the light ejected from the non-linear optical device; a reference signal generator (28) for generating a reference signal having a predetermined frequency; a phase comparator (31) for comparing a phase of a signal (S2) outputted from the photoreceiver with a pulse of the reference signal; and a loop filter (32) for outputting a control signal (S5) according to a comparison result of the phase comparator, to the light source.

According to the apparatus, the light ejected from the non-linear optical device is received by the photoreceiver, and this received signal is compared with the reference signal outputted from the reference signal generator, so that the control signal according to the comparison results is outputted to the light source thereby to control the repetition frequency of the light source.

Alternatively, in the optical sampling measurement apparatus, the feedback control section includes: a first photoreceiver (25) for receiving the light from the non-linear optical device; a second photoreceiver (41) for receiving the sampling pulse light ejected fro the light source; a frequency divider (42) for frequency-dividing a second signal (S7) outputted from the second photoreceiver at a predetermined frequency division ratio; a phase comparator (31) for comparing a phase of a first signal (S2) outputted from the first photoreceiver with a phase of the second signal (S8) frequency-divided by the frequency divider; and a loop filter (32) for outputting a control signal (S5) according to a comparison result of the phase comparator, to the light source.

According to the apparatus, the light ejected from the non-linear optical device is received by the first photoreceiver, and the sampling pulse light ejected from the light source is received by the second photoreceiver. The first signal outputted from the first photoreceiver and the second signal divided in frequency by the frequency divider so that the control signal according to the comparison results is outputted to the light source thereby to control the repetition frequency of the light source.

The invention also provides an optical sampling measurement method involving the steps of: introducing an object light and a sampling pulse light to a non-linear optical device; and measuring the object light to be measured with using a light obtained by a non-linear optical effect, further involving the step of: controlling a repetition frequency of the sampling pulse light ejected from a light source in accordance with a repetition frequency of the light obtained by the non-linear optical effect from the non-linear optical device.

In the optical sampling measurement method, the control step controls the repetition frequency of the sampling pulse light so that a difference between a frequency of one n-th (“n” is a quotient obtained by dividing a frequency of the object light by a frequency of the sampling pulse light) of a repetition frequency of the object light and the frequency of the sampling pulse light is always a predetermined value.

The optical sampling measurement apparatus and the optical sampling measurement method are advantageous in that the sampling pulse light synchronized with the object light can be obtained without any electric signal fed from the outside. As a result, the complicated configuration can be eliminated to clear the restriction on the measuring conditions so that the object light can be measured in various situations.

### BRIEF DESCRIPTION OF THE DRAWINGS

FIG. 1 is a block diagram showing the entire configuration of an optical sampling measurement apparatus according to one embodiment of the invention;

FIG. 2 is a block diagram showing a specific configuration of a controller 29;

FIG. 3 is a diagram showing examples of an object light P4 to be measured, a sampling pulse light P6 and a summed frequency light P8; and

FIG. 4 is a block diagram showing another configuration example of the optical sampling measurement apparatus.

### DETAILED DESCRIPTION OF THE PREFERRED EMBODIMENTS

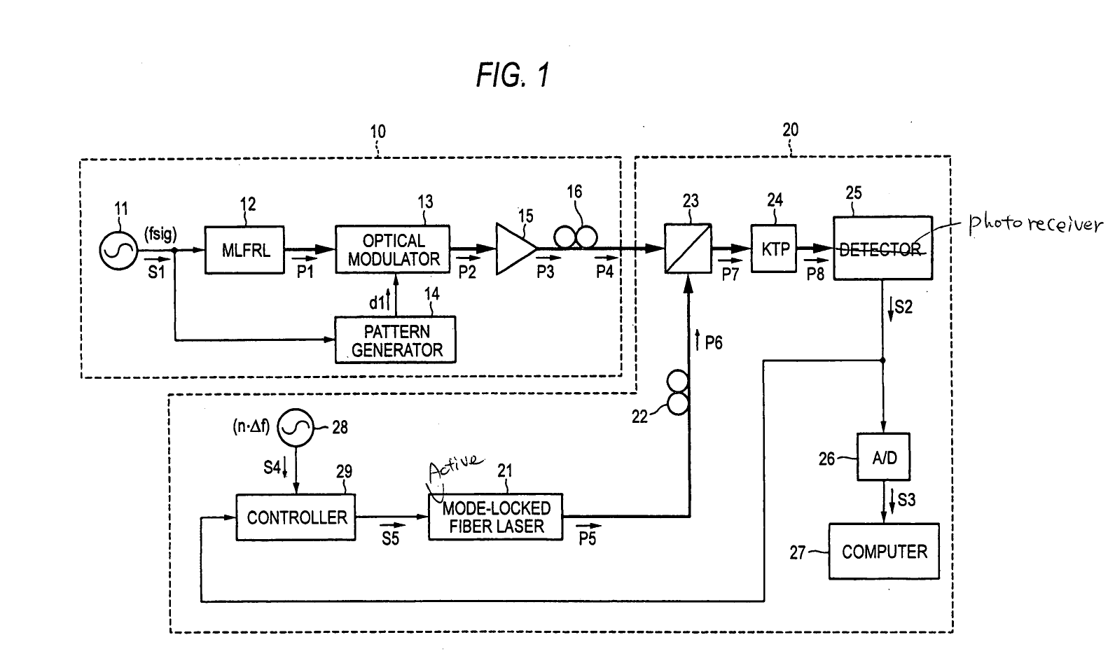

An optical sampling measurement apparatus and a method therefor according to one embodiment of the invention will be described with reference to the accompanying drawings. FIG. 1 is a block diagram showing the entire configuration of an optical sampling measurement apparatus according to one embodiment of the invention. Here in FIG. 1, electric signals to be inputted/outputted between the individual blocks are indicated by thin arrows, and light signals are indicated by thick arrows. As shown in FIG. 1, the optical sampling measurement apparatus of this embodiment is coarsely divided into a light source 10 for generating an object light P4 to be measured and a measuring device 20 for measuring the light P4. In case an optical fiber is to be tested, the light source 10 and the measuring device 20 are arranged at the individual end portions of the optical fiber to be tested. The object light P4 generated by the light source 10 is introduced into one end of the optical fiber, and the object light emitted from the other end of the optical fiber is measured by the measuring device 20.

The light source 10 is configured to include an electric signal generator 11, a mode-locked fiber ring laser (as will be called the “MLFRL”) 12, an optical modulator 13, a pattern generator 14, an erbium-doped fiber amplifier (as will be called the “EDFA”) 15 and a polarization controller 16. The electric signal generator 11 outputs an electric signal S1 for determining the repetition frequency fsig of the object light P4 generated by the light source 10. This repetition frequency fsig of the object light P4 is exemplified by about “10 GHz”. The MLFRL 12 ejects an optical pulse train P1 in synchronism with the electric signal S1 outputted from the electric signal generator 11.

The pattern generator 14 ejects a predetermined pattern as data d1 to the optical modulator 13 in synchronism with the electric signal S1 outputted from the electric signal generator 11. On the basis of the data d1 outputted from the pattern generator 14, the optical modulator 13 modulates the optical pulse train P1 ejected from the MLFRL 12, to generate an optical signal train of 10 Gb/s, for example, and ejects the signal train as a pulse light P2. The EDFA 15 amplifies the pulse light P2 ejected from the optical modulator 13, and ejects the amplified line as a pulse light P3. The polarization controller 16 controls the polarization direction of the pulse light P3 ejected from the EDFA 15, and ejects the controlled light as the object light P4. This object light P4 is inputted to the (not-shown) optical fiber to be tested.

The measuring device 20 is configured to include an active mode-locked fiber laser 21, a polarization controller 22, an optical coupler 23, a non-linear optical device 24, a photoreceiver 25, an A/D converter 26, a computer 27, a reference signal generator 28 and a controller 29. The active mode-locked fiber laser 21 ejects a sampling pulse light P5 for sampling the object light. The active mode-locked fiber laser 21 ejects a sampling pulse light having a repetition frequency fsam, in response to a control signal S5 outputted from the controller 29. The polarization controller 22 controls the polarization direction of the sampling pulse light P5 ejected from the active mode-locked fiber laser 21, and ejects the controlled light as a sampling pulse light P6.

The optical coupler 23 couples the object light P4 generated by the light source 10 and the sampling pulse light P6, and ejects a coupled light P7. This optical coupler 23 is preferably exemplified by a polarization beam splitter which can control the transmission and reflection of the object light P4 and the sampling pulse light P6 in accordance with the polarization directions of the object light P4 and the sampling pulse light P6. The non-linear optical device 24 is made of KTP (Potassium Titanyl Phosphate: KTiOPO₄) and is so arranged between the optical coupler 23 and the photoreceiver 25 that its optical axis is set to generate a summed frequency light of the object light P4 and the sampling pulse light P6. The non-linear optical device 24 ejects, when receives the coupled light P7, a summed frequency light P8.

The photoreceiver 25 is realized by an avalanche photodiode. This photoreceiver 25 subjects the summed frequency light P8, which is ejected from the non-linear optical device 24, to a photoelectric conversion, and outputs a signal S2. Between the non-linear optical device 24 and the photoreceiver 25, there is preferably interposed an optical filter for blocking the lights other than the summed frequency light P8, such as the object light P4 and the sampling pulse light P6 having passed through the non-linear optical device 24. The A/D converter 26 digitally converts the signal S2 outputted from the photoreceiver 25. Although omitted from FIG. 1, an amplifier for amplifying the signal S2 outputted from the photoreceiver 25 is preferably interposed between the photoreceiver 25 and the A/D converter 26. Moreover, this amplifier is desirably configured to automatically switch an amplification factor (or range) in accordance with the intensity of the signal S2 inputted.

The digital signal to be outputted from the A/D converter 26 is outputted as a signal S3 to the computer 27. This computer 27 is configured to include a CPU (Central Processing Unit), a storage unit such as a ROM (Read Only Memory) and a RAM (Random Access Memory), and a display unit such as a CRT (Cathode Ray Tube) or a liquid crystal display. The computer 27 measures the waveform of the object light P4 by subjecting the signal S3 outputted from the A/D converter 26, to various digital operations, and outputs the measurement results to the not-shown display unit.

The reference signal generator 28 outputs a reference signal S4 having a predetermined frequency. In case the object light P4 having the frequency fsig is sampled for an equivalent time, the frequency fsam of the sampling pulse light P5 (P6) is set to a frequency expressed by the following Formula (1):
fsam=(fsig/n)−Δf (1)

In Formula (1): letter n designates a quotient (integer) which is obtained by dividing the frequency (fsig) of the object light P4 by the center frequency of the sampling pulse light P5 (P6); and letters Δf designates a minute frequency. The frequency of the reference signal S4 outputted from the reference signal generator 28 is set to n·Δf. Here, the minute frequency Δf can be varied either by a manual adjustment of the operator or by an automatic adjustment.

Here, the frequency n·Δf of the reference signal S4 outputted from the reference signal generator 28 is equal to the repetition frequency of the summed frequency light P8 ejected from the non-linear optical device 24. On the other hand, a sampling interval Δt of the equivalent time sampling is expressed by the following Formula (2) using the frequency fsig of the object light P4, the integer n and the minute frequency Δf:
Δt≈(n²·Δf)/fsig² (2)

By adjusting the minute frequency Δf, therefore, the sampling interval Δt of the equivalent time sampling can be varied.

The controller 29 compares the phases of the signal S2 outputted from the photoreceiver 25 and the reference signal S4 outputted from the reference signal generator 28, and outputs the control signal S5 according to their difference to the active mode-locked fiber laser 21. By this control signal S5, there is controlled the repetition frequency of the sampling pulse light P5 which is ejected from the active mode-locked fiber laser 21. In short, the active mode-locked fiber laser 21 is controlled by feeding back the signal S2. Here, the controller 29 controls the active mode-locked fiber laser 21 so that the difference between the frequency of one n-th of the frequency of the object light P4 and the frequency fsam of the sampling pulse light P5 (P6) may always be at n·Δf.

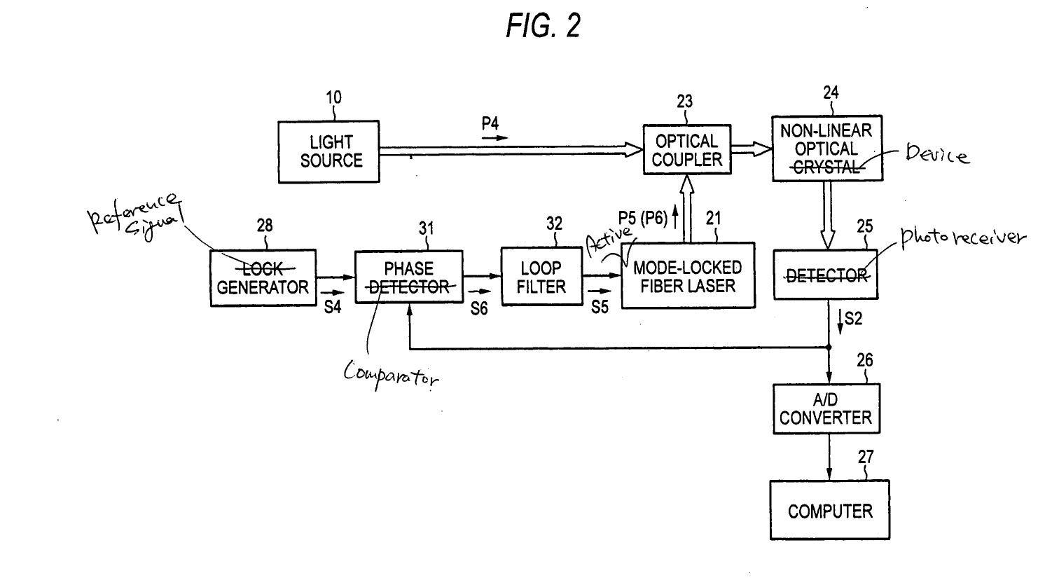

The configuration of the controller 29 will be described in the following. FIG. 2 is a block diagram showing a specific configuration of the controller 29. In order to facilitate the understanding, FIG. 2 shows the entire configuration of the optical sampling measurement apparatus. The same blocks as those shown in FIG. 1 are designated by the common reference numerals. Moreover, the electric signals to be inputted/outputted between the individual blocks are indicated by solid arrows, and the optical signals are designated by blank arrows.

As shown in FIG. 2, the controller 29 is configured to include a phase comparator 31 and a loop filter 32. The phase comparator 31 compares the phases of the reference signal S4 outputted from the reference signal generator 28 and the signal S2 outputted from the photoreceiver 25, and outputs an error signal S6 indicating that difference. The loop filter 32 outputs the control signal S5 according to the error signal S6 coming from the phase comparator 31. This control signal S5 outputted from the loop filter 32 takes the difference n·Δf between one n-th of the frequency of the object light P4 and the frequency fsam of the sampling pulse light P5 (P6).

When the electric signal S1 is outputted from the electric signal generator 11, the optical pulse train P1 is ejected from the MLFRL 12 in synchronism with the electric signal S1, and the data d1 having the predetermined pattern are outputted from the pattern generator 14 in synchronism with the electric signal S1. When the optical pulse train P1 enters the optical modulator 13, it is modulated on the basis of the data d1, and the pulse light P2 is ejected. This pulse light P2 is amplified into the pulse light P3 by the EDFA 15, and the pulse light P3 is controlled in the polarization direction by the polarization controller 16 so that it is ejected as the object light P4 from the light source 10. The object light P4 ejected from the light source 10 enters the optical coupler 23.

On the other hand, the sampling pulse light P5 ejected from the active mode-locked fiber laser 21 is controlled in the polarization direction by the polarization controller 22 and goes as the sampling pulse light P6 into the optical coupler 23. The object light P4 and the sampling pulse light P6 are coupled by the optical coupler 23 so that the coupled light P7 enters the non-linear optical device 24. When the coupled light P7 enters the non-linear optical device 24, the summed frequency light P8 between the object light P4 and the sampling pulse light P6 is generated by the non-linear optical effect and is ejected from the non-linear optical device 24.

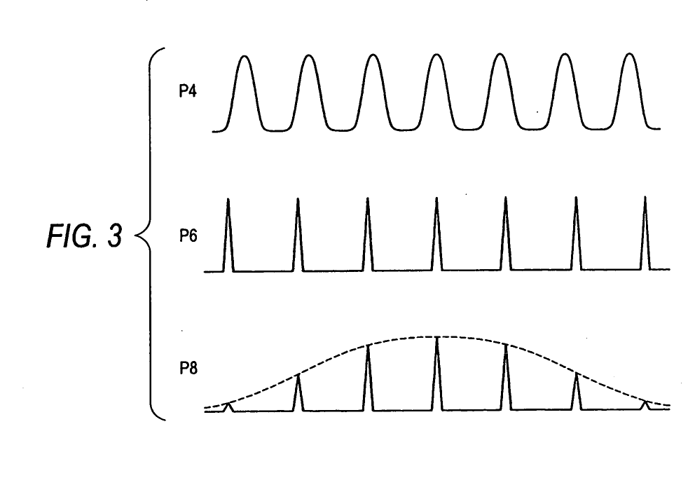

FIG. 3 is a diagram showing examples of the object light P4, the sampling pulse light P6 and the summed frequency light P8. In FIG. 3, an abscissa takes the time, and the ordinate takes the optical intensity (at an arbitrary unit). It is assumed that the object light P4 is set to the frequency fsig (of the optical pulse), and that the frequency fsam of the sampling pulse light P6 (of the optical pulse) is set to (fsig/n)−Δf. As shown in FIG. 3, the sampling pulse light P6 has a narrow pulse width like the δ function.

When the object light P4 and the sampling pulse light P6 enter the non-linear optical device 24, the summed frequency light P8 is generated only while both the object light P4 and the sampling pulse light P6 exist. The intensity of the summed frequency light P8 depends on the optical intensity of the object light P4, because the optical intensity of the sampling pulse light P6 (or the intensity of the optical pulse) is constant. Here, a minute frequency Δf is set between the object light P4 and the sampling pulse light P6 so that the envelope of the summed frequency light P8 takes such a shape that one optical pulse of the object light P4 is enlarged by fsig/(n·Δf) in the time axis direction. Moreover, the frequency (i.e., the repetition frequency), at which the envelope of the summed frequency light P8 appears, is n·Δf.

The summed frequency light P8 ejected from the non-linear optical device 24 is received by the photoreceiver 25 and is converted into the signal S2. The summed frequency light P8 has the repetition frequency n·Δf so that the signal S2 has the repetition frequency n·Δf. The signal S2 is converted into the digital signal by the A/D converter 26 so that it is inputted as the signal S3 to the computer 27. The computer 27 subjects the signal S3 to various digital operations to measure the waveform of the object light P4, and causes the measurement results in the not-shown display unit. Moreover, the signal S2 outputted from the photoreceiver 25 is inputted to the phase comparator 31 disposed in the controller 29, and is compared in phase with the reference signal S4 outputted from the reference signal generator 28 and having the frequency n·Δf.

The error signal S6 according to the phase difference between the signal S2 and the reference signal S4 is outputted from the controller 29, and the loop filter 32 outputs the control signal S5 according to the error signal S6, to the active mode-locked fiber laser 21. Here, the control signal S5 outputted from the loop filter 32 has a difference of n·Δf between the frequency of one n-th of the frequency of the object light P4 and the frequency fsam of the sampling pulse light P5 (P6).

Here, the summed frequency light P8 ejected from the non-linear optical device 24 contains the phase information of the object light P4, so that the signal S2 obtained by receiving the summed frequency light P8 also contains the phase information of the summed frequency light P8. The active mode-locked fiber laser 21 is controlled by adjusting the minute frequency Δf to set the sampling interval Δt properly and by comparing the signal S2 and the reference signal S4, on the basis of the error signal S6 according to the difference. By this control, the sampling pulse light P5 (P6) can be synchronized with the object light P4. As a result, the light P4 can be measured without feeding the active mode-locked fiber laser 21 with the electric signal synchronized with the electric signal S1 to be fed to the MLFRL 12.

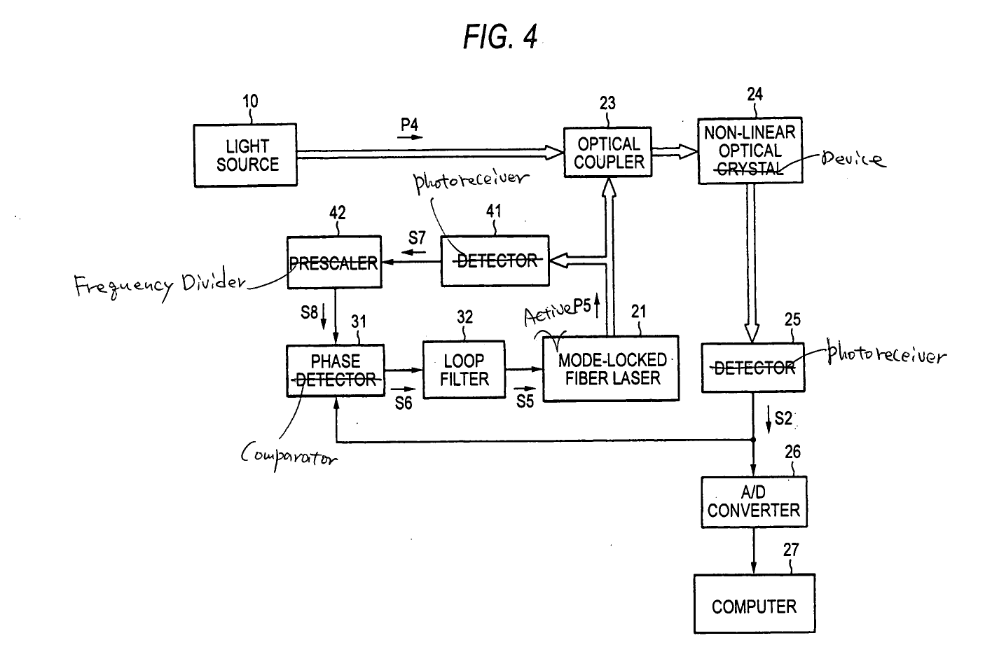

Here will be described another configuration example of the optical sampling measurement apparatus. FIG. 4 is a block diagram showing another configuration example of the optical sampling measurement apparatus. As in FIG. 2, the entire configuration of the optical sampling measurement apparatus is also shown in FIG. 4. The same blocks as those shown in FIG. 1 are designated by the common reference numerals. Moreover, the electric signals to be inputted/outputted between the individual blocks are indicated by solid arrows, and the optical signals are designated by blank arrows.

The optical sampling measurement apparatus shown in FIG. 4 is different in that the reference signal generator 28 shown in FIG. 1 and FIG. 2 is omitted and replaced by a photoreceiver 41 and a frequency divider 42. The photoreceiver 41 is realized by an avalanche photodiode. The photoreceiver 41 receives the sampling pulse light P5 ejected from the active mode-locked fiber laser 21, and outputs a signal S7. The frequency divider 42 divides the signal S7 outputted from the photoreceiver 41, at a predetermined frequency ratio, and outputs an electric signal S8 to the phase comparator 31.

In the optical sampling measurement apparatus shown in FIG. 4, too, the summed frequency light P8 ejected from the non-linear optical device 24 has the repetition frequency n·Δf so that the repetition frequency of the signal S2 is also n·Δf. Moreover, the sampling pulse light P5 ejected from the active mode-locked fiber laser 21 has the repetition frequency fsam so that the repetition frequency of the signal S7 outputted from the photoreceiver 41 is also fsam. here, the frequency of the electric signal S8 to be outputted from the frequency divider 42 is set to the same frequency (n·Δf) as that of the reference signal S4 outputted from the reference signal generator 28 shown in FIG. 1.

If the frequency divider 42 has a frequency division ratio X, therefore, a correlation of fsam/X=n·Δf holds. By modifying this correlation with the aforementioned Formula (1), therefore, the frequency division ratio X to be set at the frequency divider 42 is expressed by the following Formula (3):
X=(fsig−n·Δf)/(n²·Δf) (3)

Here is used an integer m satisfying the relation of fsig=m·Δf. Then, the Formula (3) can be expressed by the following Formula (4):
X=(m−n)/n² (4)

Therefore, the minute frequency Δf is adjusted so that the frequency fsig of the object light P4 and the minute frequency Δf take a relation of integer times, and the frequency division ratio of the frequency divider 42 is set at the frequency division ratio expressed by the Formula (4). Then, the sampling pulse light P5 (P6) can be synchronized with the object light P4. Here, the adjustment of the minute frequency Δf is synonymous with the adjustment of the sampling interval Δt of the equivalent time sampling. In the optical sampling measurement apparatus shown in FIG. 4, too, as has been described hereinbefore, the measurement of the light P4 can be performed, as in the optical sampling measurement apparatus of the configuration shown in FIG. 1, without feeding the active mode-locked fiber laser 21 with the electric signal synchronized with the electric signal S1 to be fed to the MLFRL 12.

Although the present invention has been described on its one embodiment relating to the optical sampling measurement apparatus and method, the invention should not be limited to the embodiment but its design can be freely changed within its scope. In the embodiment, for example, the active mode-locked fiber laser 21 is controlled either by providing the reference signal generator 28, the phase comparator 31 and the loop filter 32 or by providing the phase comparator 31 and the loop filter 32 and the frequency divider 42. However, these components may be configured of a computer including a CPU, a ROM and a RAM, and these functions may be realized by a software thereby to control the active mode-locked fiber laser 21.

1. An optical sampling measurement apparatus comprising: a light source for ejecting a sampling pulse light whose repetition frequency is controllable; and a non-linear optical device for receiving an object light to be measured and the sampling pulse light incident from the light source, wherein the measurement of the object light is performed by measuring a light ejected from the non-linear optical device, further comprising:
a feedback control section that controls the repetition frequency of the sampling pulse light ejected from the light source in accordance with a repetition frequency of the light ejected from the non-linear optical device.

2. The optical sampling measurement apparatus according to claim 1,
wherein the feedback control section controls the repetition frequency of the light source so that a difference between a frequency of one n-th (“n” is a quotient obtained by dividing a repetition frequency of the object light by a repetition frequency of the sampling pulse light) of a frequency of the object light and the repetition frequency of the sampling pulse light is always a predetermined value.

3. The optical sampling measurement apparatus according to claim 2,
wherein the feedback control section includes:
a photoreceiver for receiving the light ejected from the non-linear optical device;
a reference signal generator for generating a reference signal having a predetermined frequency;
a phase comparator for comparing a phase of a signal outputted from the photoreceiver with a phase of the reference signal; and
a loop filter for outputting a control signal according to a comparison result of the phase comparator, to the light source.

4. The optical sampling measurement apparatus according to claim 2,
wherein the feedback control section includes:
a first photoreceiver for receiving the light from the non-linear optical device;
a second photoreceiver for receiving the sampling pulse light ejected from the light source;
a frequency divider for frequency-dividing a second signal outputted from the second photoreceiver at a predetermined frequency division ratio;
a phase comparator for comparing a phase of a first signal outputted from the first photoreceiver with a phase of the second signal frequency-divided by the frequency divider; and
a loop filter for outputting a control signal according to a comparison result of the phase comparator, to the light source.

5. An optical sampling measurement method comprising the steps of: introducing an object light and a sampling pulse light to a non-linear optical device; and measuring the object light to be measured with using a light obtained by a non-linear optical effect, further comprising the step of:
controlling a repetition frequency of the sampling pulse light ejected from a light source in accordance with a repetition frequency of the light obtained by the non-linear optical effect from the non-linear optical device.

6. The optical sampling measurement method according to claim 5,
wherein the control step controls the repetition frequency of the sampling pulse light so that a difference between a frequency of one n-th (“n” is a quotient obtained by dividing a frequency of the object light by a frequency of the sampling pulse light) of a repetition frequency of the object light and the frequency of the sampling pulse light is always a predetermined value.
